(19) United States
(12) Patent Application Publication
(10) Pub. No.: US 2017/0144418 A1
(43) Pub. Date: May 25, 2017

(54) Anti-slippery mat and method of manufacturing thereof

(71) Applicant: Renhong CHEN, GUANGDONG PROVINCE (CN)

(72) Inventor: Renhong CHEN, GUANGDONG PROVINCE (CN)

(21) Appl. No.: 15/050,414

(22) Filed: Feb. 22, 2016

(30) Foreign Application Priority Data
Nov. 19, 2015 (CN) 201510808360.9

(51) Int. Cl. B32B 27/30

(52) U.S. Cl. CPC B32B 27/304; B32B 2255/00; B32B 2307/75; B32B 2307/744; B32B 2471/04

(57) ABSTRACT

An anti-slippery mat having a color-print layer, an upper material layer, a lower material layer and suction cups; the upper material layer and the lower material layer are pressed together by heat pressing and form a sealed integral body; a perimeter of the sealed integral body is a sealed edge formed by pressing force; the suction cups engage with a lower surface of the lower material layer by heat pressing; the color-print layer is positioned on an upper surface of the upper material layer; the upper material layer is an anti-abrasive PVC film layer; anti-slippery patterns or anti-slippery studs are arranged on the anti-abrasive PVC film layer; the lower material layer is a foam layer foamed after a plurality of PVC film layers are pressed against one another by heating pressing.

### BACKGROUND OF THE INVENTION

The present invention belongs to the technical field of manufacturing an anti-slippery mat, and more specifically relates to a method of manufacturing an anti-slippery mat and the anti-slippery mat being manufactured.

The use of anti-slippery mat is getting more popular especially in bathroom following gradual social development. Many households nowadays use tiles for their bathroom floors. Tiles have smooth surfaces which are slippery when water drops on the tiles during shower. Some anti-slippery mats have been disclosed having a layered structure, meaning that an anti-slippery layer and a rubber layer are adhered by adhesives, wherein the adhesives constitute another adhesive layer. This kind of glued layered structure causes different layers to contract differently due to chemical migration between different chemical compounds in different layers, and thus causes the anti-slippery mat to curl and hence lowering its anti-slippery ability and increasing the discomfort during use. Besides, disposal of this kind of anti-slippery mat causes environmental problems and the need of waste processing. Therefore, it is desired to have a kind of anti-slippery mat which achieves equivalent or even better anti-slippery effect, increases the comfortability during use and at the same time reduces the use of materials to alleviate the problem of high waste processing volume. It is particularly important in today's world which is gradually shortened with resources and more aware of environmentally friendliness.

### BRIEF SUMMARY OF THE INVENTION

In view of the aforesaid disadvantages now present in the prior art, the present invention provides an anti-slippery mat which is mildew proof and comfortable to use. A method of manufacturing said anti-slippery mat is also provided.

The present invention is achieved by the following technical scheme:

An anti-slippery mat, comprising a color-print layer, an upper material layer, a lower material layer and suction cups; the upper material layer and the lower material layer are pressed together by heat pressing and form a sealed integral body; a perimeter of the sealed integral body is a sealed edge formed by pressing force; the suction cups 5 engage with a lower surface of the lower material layer by heat pressing; the color-print layer is positioned on an upper surface of the upper material layer; the upper material layer is an anti-abrasive polyvinyl chloride (PVC) film layer; anti-slippery patterns or anti-slippery studs are arranged on the anti-abrasive PVC film layer; the lower material layer is a foam layer foamed after a plurality of PVC film layers are pressed against one another by heating pressing.

A method of manufacturing the anti-slippery mat, comprising the following steps:

Pressing a plurality of PVC film layers at 145-180° C. by thermoplastic mold pressing to form a main body of the anti-slippery mat, wherein an uppermost layer of the main body is a PVC film layer containing anti-abrasive ingredient while other layers of the main body each contains a foaming agent;

Heating up the main body to 210-230° C., so that the PVC film layers each containing a foaming agent in the main body are foamed to form a foamed layer, wherein the foamed layer constitutes a lower material layer of the anti-slippery mat and the PVC film layer containing anti-abrasive ingredient constitutes an upper material layer of the anti-slippery mat;

Making anti-slippery patterns or anti-slippery studs on the foamed and formed anti-slippery mat by pressing the upper material layer using an embossing roller;

Forming a color-print layer by printing visually appealing indicia on the upper material layer through screen printing, spray printing or thermal transfer printing;

Engaging suction cups to a lower surface of the lower material layer of the anti-slippery mat by heat pressing, and performing edge pressing and sealing around a perimeter of the anti-slippery mat.

The present invention has the following obvious advantages and beneficial effects compared with existing prior arts by forming a main body of the anti-slippery mat through foaming after a PVC film layer containing anti-abrasive ingredient is pressed against a plurality of PVC film layers each containing a foaming agent: 1. Since the entire anti-slippery mat is made by PVC film layers, the anti-slippery mat is mildew proof; also, a plurality of PVC film layers are softened and foamed after foaming, thereby contributing to buffering effect resulting in better anti-slippery effect and greater comfortability for users to stand onto; 2. Since the entire anti-slippery mat is formed by heat pressing of PVC film layers rather than by using adhesives, the present invention prevents the problem of different degrees of contraction of different layers due to chemical migration between different chemical compounds in different layers, thereby stabilizing the entire structure of the anti-slippery mat for better effect of use; 3. By using a PVC film layer containing anti-abrasive ingredient in the upper material layer, the entire anti-slippery mat is more resistant to abrasion during use and thus being benefited with a longer service life; 4. Suction cups are arranged below the main body for fixing the anti-slippery mat firming on the ground to achieve highly effective anti-slippery effect; 5. Visually appealing indicia is screen printed on the main body for decoration so that the entire anti-slippery mat is more visually appealing; 6. Anti-slippery patterns or anti-slippery studs are provided on the PVC film layer containing anti-abrasive ingredient so that users can stand more firmly on the anti-slippery mat during use, thereby achieving better anti-slippery effect and promoting more safety use of the anti-slippery mat.

The present invention is further described in detail below with reference to the accompanying drawings and embodiments to better explain the structural characteristics, technical means as well as the specific purposes and functions of the present invention.

### BRIEF DESCRIPTION OF THE DRAWINGS

FIG. 1 is a sectional view showing a structure of the anti-slippery mat according to the present invention.

FIG. 2 is a top plan view of the anti-slippery mat according to the present invention.

### DETAILED DESCRIPTION OF THE INVENTION

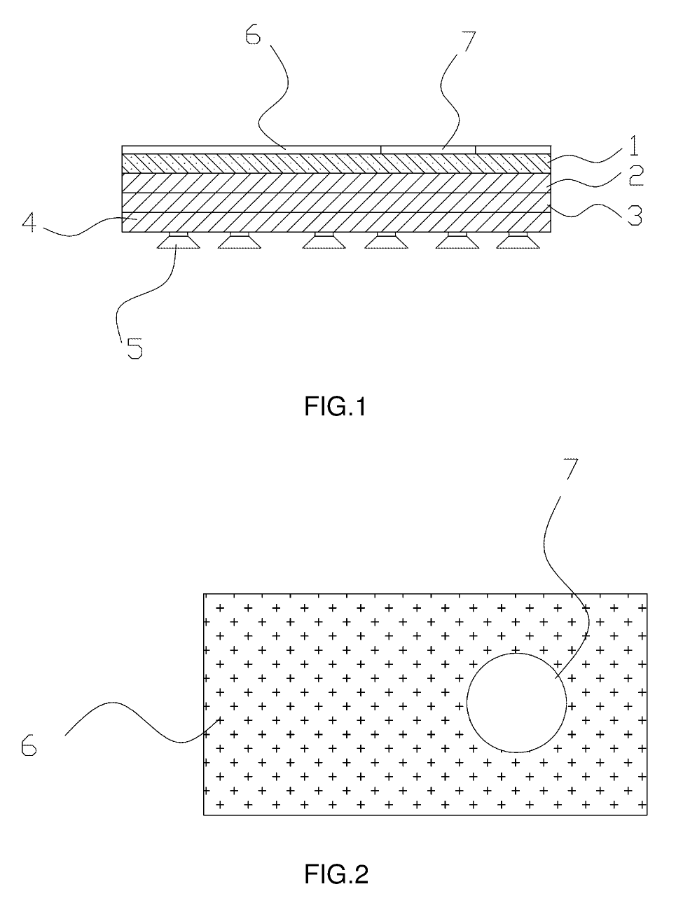

As shown in FIG. 1, an anti-slippery mat comprises a color-print layer 6, an upper material layer, a lower material layer and suction cups 5. The upper material layer and the lower material layer are pressed together by heat pressing and form a sealed integral body. A perimeter of the sealed integral body is a sealed edge formed by pressing force. The suction cups 5 engage with a lower surface of the lower material layer by heat pressing. The upper material layer is a first polyvinyl chloride (PVC) film layer 1 containing anti-abrasive ingredient. The additional use of the anti-abrasive ingredient prolongs the service life of the anti-slippery mat. Anti-slippery patterns or anti-slippery studs are provided on the first PVC film layer 1 to enhance the anti-slippery effect. The anti-slippery patterns or anti-slippery studs are made by using an embossing roller. An upper surface of the first PVC film layer 1 is provided with the color-print layer 6. Color indicia which is visually appealing is printed on the color-print layer 6 by screen printing, spray printing or thermal transfer printing to elevate the mood of users during the use of the anti-slippery mat and make the use thereof an enjoyable experience. The lower material layer is a foam layer foamed after a second PVC film layer 2, a third PVC film layer 3 and a fourth PVC film layer 4 are pressed against one another by heating pressing. As said, the perimeter of the anti-slippery mat has the sealed edge formed by pressing force. Such sealed edge can protect the anti-slippery mat to increase its service life. The foamed layer of the anti-slippery mat can be formed by foaming of three PVC film layers. In order to increase the thickness of the anti-slippery mat, the foamed layer can be formed by foaming of more than three PVC film layers.

As shown in FIG. 2, a temperature indication zone 7 is provided on the upper material layer. The temperature indication zone 7 is provided with an ink layer which changes color responsive to changes in temperature. Particularly, the ink layer has a faded color when its temperature is higher than a preset value, and returns to its original color when it is cooled down. The preset value of the temperature of the ink layer ranges from 32-40° C., preferably 37° C. Through the color changes of the ink layer responsive to changes in temperature, water temperature is indicated to prevent users from being scalded.

Embodiment 1 of a method of manufacturing the anti-slippery mat of the present invention: the anti-slippery mat is manufactured according to the following steps:

Pressing a PVC film layer containing anti-abrasive ingredient against four other PVC film layers each containing a foaming agent at 145° C. by thermoplastic mold pressing to form a main body of the anti-slippery mat, wherein the PVC film layer containing anti-abrasive ingredient is positioned as an uppermost layer of the main body;

Heating up the main body to 210° C., so that the PVC film layers each containing a foaming agent in the main body are foamed to form a foamed layer, wherein the foamed layer constitutes a lower material layer of the anti-slippery mat and the PVC film layer containing anti-abrasive ingredient constitutes an upper material layer of the anti-slippery mat;

Making anti-slippery patterns or anti-slippery studs by pressing the upper material layer using an embossing roller to achieve enhanced anti-slippery effect of the anti-slippery mat;

Forming a color-print layer by printing visually appealing indicia on the upper material layer through screen printing, spray printing or thermal transfer printing;

Cutting the foamed and formed anti-slippery mat into a predetermined shape after the indicia is printed;

Engaging suction cups to a lower surface of the lower material layer of the anti-slippery mat being cut into the predetermined shape by heat pressing;

Heat pressing of the suction cups to the lower surface of the lower material layer of the anti-slippery mat comprises the following steps:

Arranging the suction cups on a lower mold of an electrical heat pressing mold according to predetermined spacings;

Placing the lower surface of the lower material layer of the anti-slippery mat on the suction cups;

Performing heat pressing by using an upper mold of the electrical heat pressing mold so that the suction cups are attached to the lower surface of the lower material layer.

Since a perimeter of the lower mold of the electrical heat pressing mold and a perimeter of the upper mold of the electrical heat pressing mold are each provided with edge pressing configuration, the edge pressing configurations of the lower mold and the upper mold cooperate when the suction cups are pressed against the lower material layer to create a sealed edge formed by pressing force around a cutting perimeter of the anti-slippery mat. The sealed edge has a thickness smaller than a thickness of a middle part of the anti-slippery mat.

Embodiment 2 of a method of manufacturing the anti-slippery mat of the present invention: the anti-slippery mat is manufactured according to the following steps:

Pressing a PVC film layer containing anti-abrasive ingredient against three other PVC film layers each containing a foaming agent at 160° C. by thermoplastic mold pressing to form a main body of the anti-slippery mat, wherein the PVC film layer containing anti-abrasive ingredient is positioned as an uppermost layer of the main body;

Heating up the main body to 220° C., so that the PVC film layers each containing a foaming agent in the main body are foamed to form a foamed layer, wherein the foamed layer constitutes a lower material layer of the anti-slippery mat and the PVC film layer containing anti-abrasive ingredient constitutes an upper material layer of the anti-slippery mat;

Making anti-slippery patterns or anti-slippery studs by pressing the upper material layer using an embossing roller to achieve enhanced anti-slippery effect of the anti-slippery mat;

Forming a color-print layer by printing visually appealing indicia on the upper material layer through screen printing, spray printing or thermal transfer printing;

Cutting the foamed and formed anti-slippery mat into a predetermined shape after the indicia is printed;

Engaging suction cups to a lower surface of the lower material layer of the anti-slippery mat being cut into the predetermined shape by heat pressing;

Heat pressing of the suction cups to the lower surface of the lower material layer of the anti-slippery mat comprises the following steps:

Arranging the suction cups on a lower mold of an electrical heat pressing mold according to predetermined spacings;

Placing the lower surface of the lower material layer of the anti-slippery mat on the suction cups;

Performing heat pressing by using an upper mold of the electrical heat pressing mold so that the suction cups are attached to the lower surface of the lower material layer.

Since a perimeter of the lower mold of the electrical heat pressing mold and a perimeter of the upper mold of the electrical heat pressing mold are each provided with edge pressing configuration, the edge pressing configurations of the lower mold and the upper mold cooperate when the suction cups are pressed against the lower material layer to create a sealed edge formed by pressing force around a cutting perimeter of the anti-slippery mat. The sealed edge has a thickness smaller than a thickness of a middle part of the anti-slippery mat.

In order that the anti-slippery mat is equipped with temperature indication function, a temperature indication zone is provided on the upper material layer, wherein the temperature indication zone is covered with an ink layer that changes color responsive to changes in temperature, where the ink layer has a faded color when its temperature is higher than a predetermined value, and returns to its original color when it is cooled down.

Embodiment 3 of a method of manufacturing the anti-slippery mat of the present invention: the anti-slippery mat is manufactured according to the following steps:

Pressing a PVC film layer containing anti-abrasive ingredient against five other PVC film layers each containing a foaming agent at 180° C. by thermoplastic mold pressing to form a main body of the anti-slippery mat, wherein the PVC film layer containing anti-abrasive ingredient is positioned as an uppermost layer of the main body;

Heating up the main body to 230° C., so that the PVC film layers each containing a foaming agent in the main body are foamed to form a foamed layer, wherein the foamed layer constitutes a lower material layer of the anti-slippery mat and the PVC film layer containing anti-abrasive ingredient constitutes an upper material layer of the anti-slippery mat;

Making anti-slippery patterns or anti-slippery studs by pressing the upper material layer using an embossing roller to achieve enhanced anti-slippery effect of the anti-slippery mat;

Forming a color-print layer by printing visually appealing indicia on the upper material layer through screen printing, spray printing or thermal transfer printing;

Cutting the foamed and formed anti-slippery mat into a predetermined shape after the indicia is printed;

Engaging suction cups to a lower surface of the lower material layer of the anti-slippery mat being cut into the predetermined shape by heat pressing;

Heat pressing of the suction cups to the lower surface of the lower material layer of the anti-slippery mat comprises the following steps:

Arranging the suction cups on a lower mold of an electrical heat pressing mold according to predetermined spacings;

Placing the lower surface of the lower material layer of the anti-slippery mat on the suction cups;

Performing heat pressing by using an upper mold of the electrical heat pressing mold so that the suction cups are attached to the lower surface of the lower material layer.

Since a perimeter of the lower mold of the electrical heat pressing mold and a perimeter of the upper mold of the electrical heat pressing mold are each provided with edge pressing configuration, the edge pressing configurations of the lower mold and the upper mold cooperate when the suction cups are pressed against the lower material layer to create a sealed edge formed by pressing force around a cutting perimeter of the anti-slippery mat. The sealed edge has a thickness smaller than a thickness of a middle part of the anti-slippery mat.

In the above embodiments 1-3, the foaming agent comprises the following components in terms of part by weight:

| | | |
|---|---|---|
| Salicylic acid | 3-6 | parts |
| P-Toluenesulfonyl Semicarbazide | 3-5 | parts |
| Ammonium carbonate | 5-7 | parts |
| Urea | 0.8-2.5 | parts |
| Benzoic acid | 2-4 | parts |
| Propylene glycol | 13-22 | pats |
| Calcium oxide | 3-5 | parts |

What is claimed is:

1. An anti-slippery mat, comprising a color-print layer, an upper material layer, a lower material layer and suction cups; the upper material layer and the lower material layer are pressed together by heat pressing and form a sealed integral body; a perimeter of the sealed integral body is a sealed edge formed by pressing force; the suction cups engage with a lower surface of the lower material layer by heat pressing; the color-print layer is positioned on an upper surface of the upper material layer; the upper material layer is an anti-abrasive polyvinyl chloride (PVC) film layer; anti-slippery patterns or anti-slippery studs are arranged on the anti-abrasive PVC film layer; the lower material layer is a foam layer foamed after a plurality of PVC film layers are pressed against one another by heating pressing.

2. The anti-slippery mat according to claim 1, wherein the color-print layer is attached to an upper surface of the anti-abrasive PVC film layer through screen printing, spray printing or thermal transfer printing.

3. The anti-slippery mat according to claim 1, wherein a temperature indication zone is provided on the upper material layer; the temperature indication zone is covered with an ink layer that changes color responsive to changes in temperature, where the ink layer has a faded color when a temperature of the ink layer is higher than a predetermined value, and returns to an original color when the ink layer is cooled down.

4. A method of manufacturing an anti-slippery mat, comprising the following steps:
1. pressing a plurality of PVC film layers at 145-180° C. by thermoplastic mold pressing to form a main body of the anti-slippery mat, wherein an uppermost layer of the main body is a PVC film layer containing anti-abrasive ingredient while other layers of the main body each contains a foaming agent;
2. heating up the main body to 210-230° C., so that the PVC film layers each containing a foaming agent in the main body are foamed to form a foamed layer, wherein the foamed layer constitutes a lower material layer of the anti-slippery mat and the PVC film layer containing anti-abrasive ingredient constitutes an upper material layer of the anti-slippery mat;
3. making anti-slippery patterns or anti-slippery studs on the foamed and formed anti-slippery mat by pressing the upper material layer using an embossing roller;
4. forming a color-print layer by printing visually appealing indicia on the upper material layer through screen printing, spray printing or thermal transfer printing;
5. engaging suction cups to a lower surface of the lower material layer of the anti-slippery mat by heat pressing, and performing edge pressing and sealing around a perimeter of the anti-slippery mat.

5. The method of manufacturing an anti-slippery mat according to claim 4, wherein the foaming agent comprises the following components in terms of part by weight:

| | | |
|---|---|---|
| Salicylic acid | 3-6 | parts |
| P-Toluenesulfonyl Semicarbazide | 3-5 | parts |
| Ammonium carbonate | 5-7 | parts |
| Urea | 0.8-2.5 | parts |
| Benzoic acid | 2-4 | parts |
| Propylene glycol | 13-22 | pats |
| Calcium oxide | 3-5 | parts |

6. The method of manufacturing an anti-slippery mat according to claim 4, wherein in step 1, the plurality of PVC film layers are pressed to form the main body of the anti-slippery mat at 160° C.; and in step 2, the PVC film layers each containing a foaming agent are foamed to form the foamed layer when the main body has a temperature of 220° C.

7. The method of manufacturing an anti-slippery mat according to claim 4, wherein step 5 comprises the following sub-steps: arranging the suction cups on a lower mold of an electrical heat pressing mold according to predetermined spacings; placing the lower surface of the lower material layer of the anti-slippery mat on the suction cups; performing heat pressing by using an upper mold of the electrical heat pressing mold so that the suction cups are attached to the lower surface of the lower material layer.

8. The method of manufacturing an anti-slippery mat according to claim 4, wherein a perimeter of the lower mold of the electrical heat pressing mold and a perimeter of the upper mold of the electrical heat pressing mold are each provided with edge pressing configuration, the edge pressing configurations of the lower mold and the upper mold cooperate when the suction cups are pressed against the lower material layer to create a sealed edge formed by pressing force around a cutting perimeter of the anti-slippery mat; the sealed edge has a thickness smaller than a thickness of a middle part of the anti-slippery mat.
